(19) United States
(12) Patent Application Publication
(10) Pub. No.: US 2008/0126356 A1
(43) Pub. Date: May 29, 2008

(54) Web service management systems and methods

(75) Inventors: Jacob Guo, Taichung (TW); Jui-Min Jiang, Taipei (TW); Chih-Hao Hsu, Taipei (TW)

Correspondence Address: BIRCH STEWART KOLASCH & BIRCH, PO BOX 747, FALLS CHURCH, VA, 22040-0747, US

(73) Assignee: Institute for Information Industry

(21) Appl. No.: 11/641,704

(22) Filed: Dec. 20, 2006

(30) Foreign Application Priority Data
Nov. 8, 2006 (TW) 95141288

(51) Int. Cl. G06F 17/30; G06F 7/00

(52) U.S. Cl. 707/10; 707/E17.032

(57) ABSTRACT

Web service management systems and methods are disclosed. Non-centralized registration and search mechanisms for web services in a distributed environment are provided. Service information of web services and network addresses of service nodes is transformed, as well as registration and search functions for web services based on service keys and node IDs obtained during transformation.

### BACKGROUND OF THE INVENTION

1. Field of the Invention

The disclosure relates generally to web service management, and, more particularly to systems and methods for web services in a distributed environment comprising non-centralized registration and search mechanisms.

2. Description of the Related Art

Various web services, provided for users via network connection are available on the Internet. Because of the great number of web services available, a web service registration system has been developed to provide an integrated registration mechanism, allowing users to search for required web services.

A current web service registration system such as a Universal Description, Discovery, and Integration (UDDI) server can store company names providing web services, web service classifications, web service descriptions, web service methods, formats for input and output parameters of the methods, and others.

The web service registration system is a centralized management system. For example, all service providers must register their web services on a specific UDDI server, and all users must search for required web services on a specific UDDI server. In the conventional architecture, performance and reliability risks may exist in the web service registration system. If a large number of users connect to the system to search for web services, system performance may suffer. If the system fails, all services such as registration and search are suspended.

### BRIEF SUMMARY OF THE INVENTION

Web service management systems and methods are provided. The invention provides non-centralized registration and search mechanisms for web services in a distributed environment. The invention transforms service information of web services and network addresses of service nodes, and performs registration and search for web services based on service keys and node IDs obtained during transformation. The system risks inherent to the conventional centralized architecture can be reduced, thereby ensuring system performance and strengthening system flexibility and reliability.

An embodiment of a web service management system comprises a plurality of service nodes, each having a node ID, where the node ID is obtained by encoding a network address of the service node using an encoding function. A first service node has at least one web service. The first service node uses the encoding function to encode at least service information of the web service to obtain a service key, and selects one of the service nodes accordingly, where the difference between the node ID of the selected service node and the service key is minimum. The first service node registers the service key, the node ID of the first service node, and the service information to the selected service node.

An embodiment of a web service management system comprises a plurality of service nodes, each having a node ID, where the node ID is obtained by encoding a network address of the service node using an encoding function. Each service node comprises a service address book and a service description repository. The service address book comprises the node ID and network address of at least one service node. The service description repository comprises node ID of at least one service node providing at least one web service, at least service information corresponding to the web service, and a service key corresponding to the service information. When a second service node seeks a specific web service, a specific keyword corresponding to the specific web service is encoded using the encoding function to obtain a specific service key corresponding to the specific keyword, and selects a first query node from the service nodes accordingly, where the difference between the specific service key and the node ID of the first query node is minimal. The second service node queries a specific service node corresponding to the specific service key from the service description repository of the first query node.

In an embodiment of a web service management method, a plurality of service nodes is provided. Each service node has a node ID, where the node ID is obtained by encoding a network address of the service node using an encoding function. A first service node having at least one web service utilizes the encoding function to encode at least service information of the web service to obtain a service key. One of the service nodes is selected according to the service key, where the difference between the node ID of the selected service node and the service key is minimal. The service key, the node ID of the first service node, and the service information are registered to the selected service node.

In an embodiment of a web service management method, a plurality of service nodes is provided. Each service node has a node ID, where the node ID is obtained by encoding a network address of the service node using an encoding function. A service address book and a service description repository are provided in each service node, where the service address book comprises the node ID and network address of at least one service node, and the service description repository comprises the node ID of at least one service node providing at least one web service, at least service information corresponding to the web service, and a service key corresponding to the service information. When a second service node seeks a specific web service, a specific keyword corresponding to the specific web service is encoded using the encoding function to obtain a specific service key corresponding to the specific keyword. A first query node is selected from the service nodes according to the specific service key, where the difference between the specific service key and the node ID of the first query node is minimal. A specific service node corresponding to the specific service key is queried from the service description repository of the first query node.

Web service management systems and methods may take the form of program code embodied in a tangible media. When the program code is loaded into and executed by a machine, the device becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a web service management system;

FIG. 2 is a schematic diagram illustrating an embodiment of a service node;

FIG. 3 is a schematic diagram illustrating an example of a service address book;

FIG. 4 is a schematic diagram illustrating an example of a service description repository;

FIG. 5 is a flowchart of an embodiment of a method for web service registration;

FIG. 6 is a flowchart of an embodiment of a method for web service search;

FIG. 7 shows an example of web service registration; and

FIG. 8 shows an example of web service search.

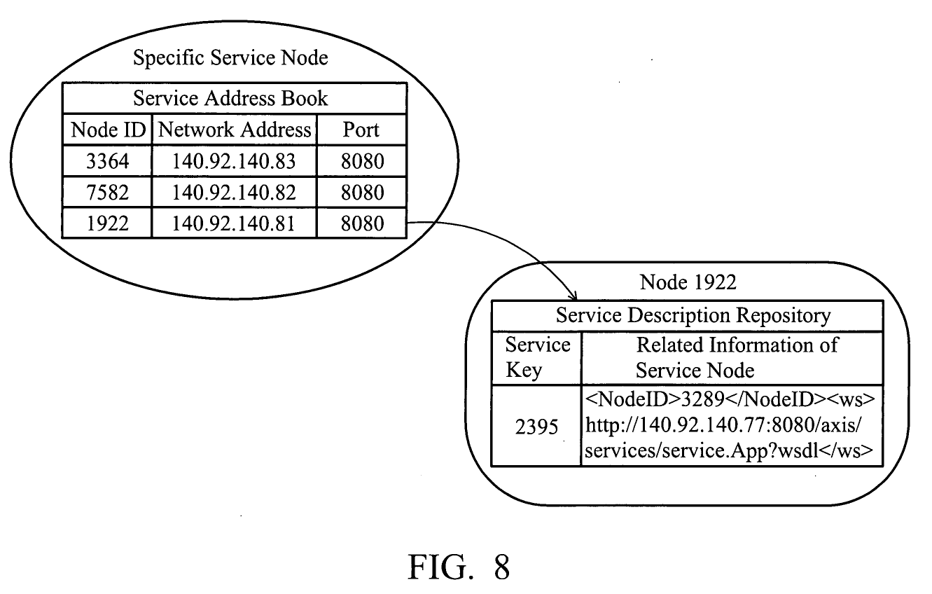

### DETAILED DESCRIPTION OF THE INVENTION

Web service management systems and methods are provided.

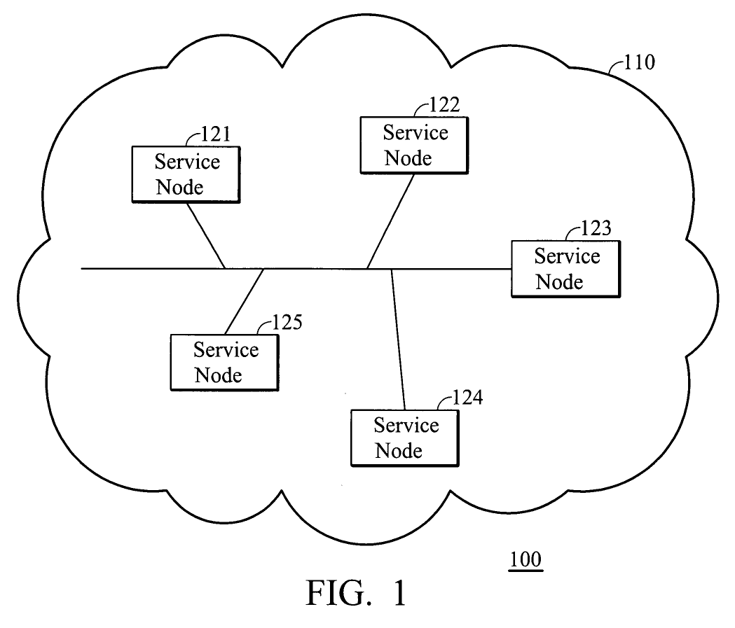

FIG. 1 illustrates an embodiment of a web service management system.

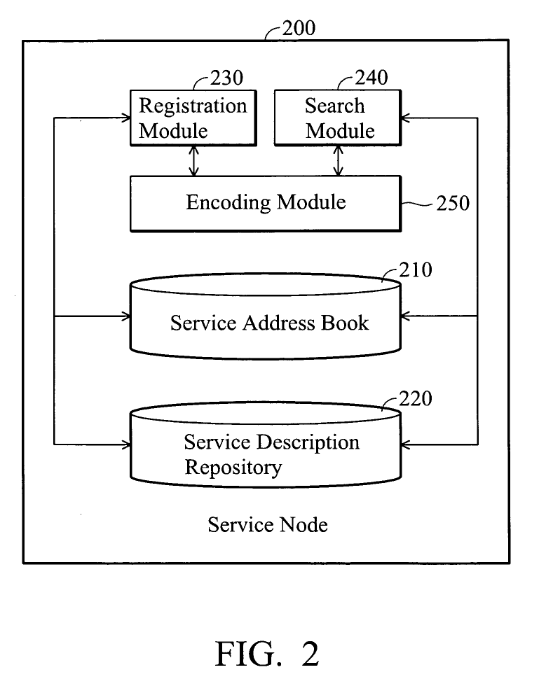

The web service management system 100 for use in a plurality of service nodes 121, 122, 123, 124 and 125 in a service network 110, such as a local area network or the Internet. In the present invention, a service node may have one or several web services, and may receive registration for web services from other service nodes. FIG. 2 illustrates an embodiment of a service node. As shown in FIG. 2, a service node 200 comprises a service address book 210, a service description repository 220, a registration module 230, a search module 240, and an encoding module 250. The encoding module 250 has an encoding function. The node ID of each service node is obtained by encoding a network address of the service node and a time stamp using the encoding function. In some embodiments, the encoding function may be a hash function, such as MD5 or SHA-1. The registration module 230 can register web services to other service nodes in the service network 110. The search module 240 seeks web services in the service network 110 according to specific keywords.

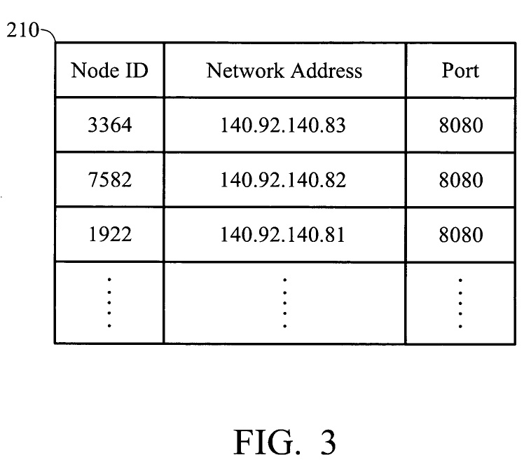

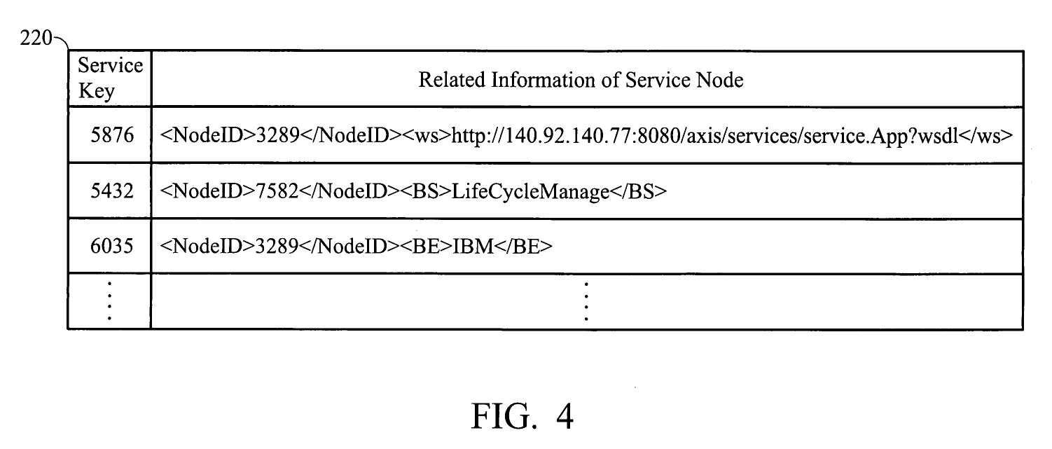

The service address book 210 records location information of service nodes in the service network 110. The location information comprises the node ID and network address such as an IP address and port number of a service node. FIG. 3 illustrates an embodiment of an example of a service address book. In FIG. 3, three entries in the service address book 210, each recording the network address and port number for service nodes “3364”, “7582” and “1922”, respectively. The service description repository 220 records service keys defined by service nodes in the service network 110 and related information of service nodes. The related information comprises node ID of service nodes providing web services and service information corresponding to web services. The service information comprises keywords of BE (Business Entity), BS (Business Service) and WS (Web Service). FIG. 4 illustrates an embodiment of an example of a service description repository. In FIG. 4, three entries in the service description repository 220. The second entry, for example, records node ID “7582” of a service node providing a web service having service key “1922”, and service information “LifeCycleManage” corresponding to service key “1922”. It is understood that the service key is obtained by the encoding module 250 encoding the service information using the encoding function.

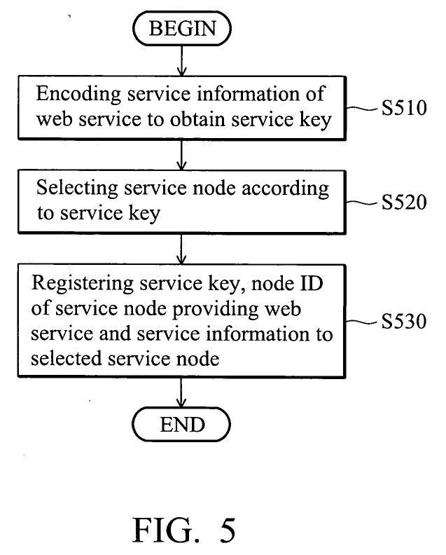

FIG. 5 is a flowchart of an embodiment of a method for web service registration.

In step S510, a service node having at least one web service uses the encoding function to encode at least service information of the web service to obtain a service key. As described, the service information comprises keywords of BE, BS and WS. Several service keys may be generated for one web service according to service information. In step S520, at least one of the service nodes is selected according to the service key. In some embodiments, the service key is compared with the node IDs recorded in the service address book, and one of the service nodes recorded in the service address book is selected. The difference between the service key and the node ID of the selected service node is minimal (ABS(node ID-service key)). In step S530, the service key, the node ID of the service node providing the web service, and the service information are registered to the service description repository of the selected service node.

It is understood that, in some embodiments, it is determined whether another new service node nearer to the service key is recorded in the service address book of the selected service node. That is, to determine whether the difference between the service key and the new service node is still less than the original difference. If so, the service key, the node ID of the service node providing the web service, and the service information are registered to the selected service node and the new service node, or only registered to the new service node.

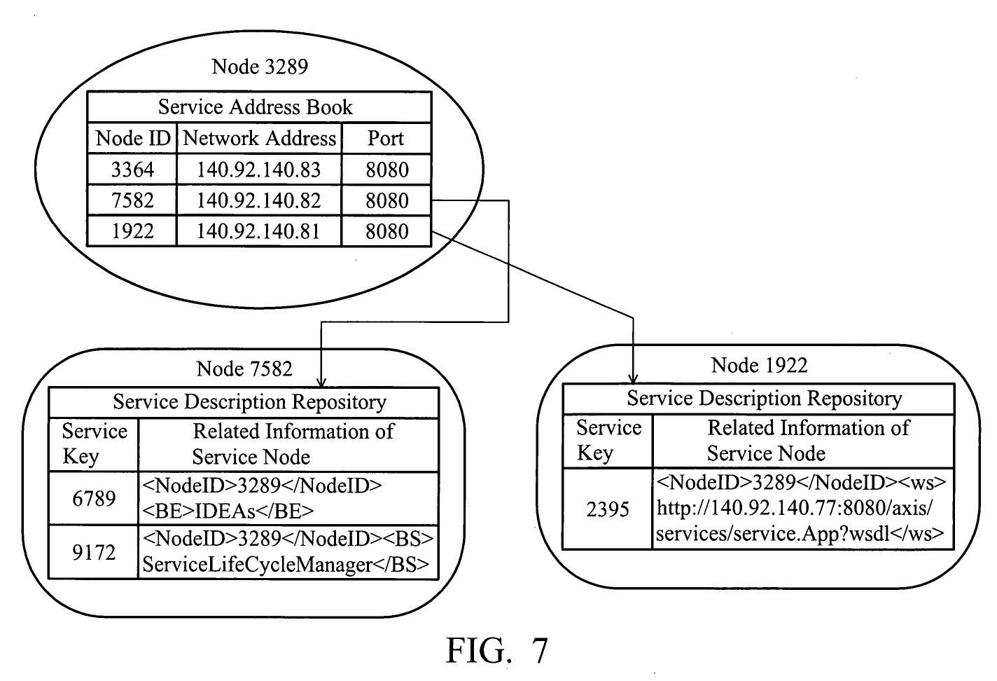

An example follows. If a service node with node ID “3289” has a web service and a service address book 210 as shown in FIG. 3. The web service has service information comprising “IDEAs”, “ServiceLifeCycleManager”, and “Online Management”, where service keys corresponding to “IDEAs”, “ServiceLifeCycleManager”, and “Online Management” are “6789”, “9172” and “2395”. After comparing the service keys to the node IDs in the service address book 210, the service information “IDEAs” and “ServiceLifeCycleManager”, corresponding service keys “6789” and “9172”, and node ID “3289” are registered to the service description repository of the service node with node ID “7582”. The service information “Online Management”, corresponding service key “2395”, and node ID “3289” are registered to the service description repository of the service node with node ID “1922”, as shown in FIG. 7.

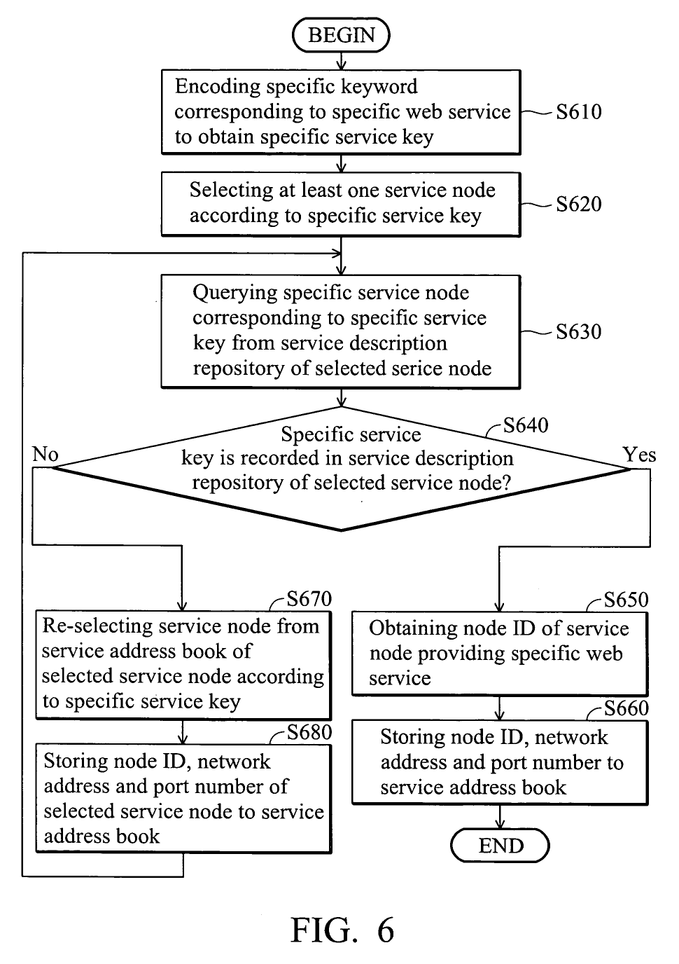

FIG. 6 is a flowchart of an embodiment of a method for web service search.

If a service node seeks a specific web service, in step S610, a keyword corresponding to the specific web service is encoded using the encoding function to obtain a specific service key corresponding to the keyword. In step S620, at least one service node (query node) is selected according to the specific service key for seeking web services. In some embodiments, the specific service key is compared with the node IDs recorded in the service address book, and one of the service nodes recorded in the service address book is selected. The difference between the specific service key and the node ID of the selected service node is minimal. In step S630, a specific service node corresponding to the specific service key is queried from the service description repository of the selected service node. In step S640, it is determined whether the specific service key is recorded in the service description repository of the selected service node. If so (Yes in step S640), in step S650, the node ID of a service node providing the specific web service is retrieved from the service description repository of the selected service node according to the specific service key. In step S660, the node ID, network address and port number of the service node are retrieved from the service address book of the selected service node, and the retrieved information is recorded in the service address book of the service node seeking the specific web service. After the node ID of the service node providing the specific web service is obtained, the user (the service node seeking the specific web service) can link to the service node according to the network address and the port number recorded in the service address book, and use the specific web service. If not (No in step S640), in step S670, another service node (query node) is re-selected according to the specific service key, where the difference between the specific service key and the node ID of the new service node is minimal. In step S680, the node ID, network address and port number of the new service nodes are received, and recorded in the service address book. Thereafter, the procedure returns to step S630. The procedure is repeated until the specific service key is recorded in the service description repository of the selected service node.

An example follows. A specific service node wants to search for a web service with the keyword “Online Management”, and the specific service node has a service address book 210 as shown in FIG. 3. The service node first uses the encoding function to encode keyword “Online Management” to obtain a service key “2395”. The service key “2395” is compared with the service address book 210. Since the difference of node ID “1922” and the service key “2395” is minimum, node ID “1922” is selected as a query node for query. Since the service key “2395” is recorded in the service description repository of the service node “1922”, the service node “1922” transmits service information corresponding to the service key “2395” and node ID of a service node providing a web service corresponding to key word “Online Management” to the specific service node.

Accordingly, the invention provides non-centralized registration and search mechanisms for web services in a distributed environment. The invention transforms service information of web services and network addresses of service nodes, and performs registration and search for web services based on service keys and node ID obtained during transformation. The system risks of the conventional centralized architecture can be reduced, thereby ensuring system performance and strengthening system flexibility and reliability.

Web service management systems and methods, or certain aspects or portions thereof, may take the form of program code (i.e., executable instructions) embodied in tangible media, such as floppy diskettes, CD-ROMS, hard drives, or any other machine-readable storage medium, wherein, when the program code is loaded into and executed by a machine, such as a computer, the device thereby becomes an apparatus for practicing the methods. The methods may also be embodied in the form of program code transmitted over some transmission medium, such as electrical wiring or cabling, through fiber optics, or via any other form of transmission, wherein, when the program code is received and loaded into and executed by a machine, such as a computer, the device becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the invention shall be defined and protected by the following claims and their equivalents.

What is claimed is:

1. A web service management system, comprising:
a plurality of service nodes, each having a node ID, where the node ID is obtained by encoding a network address of the service node using an encoding function; and
a first service node within the service nodes, having at least one web service, using the encoding function to encode at least service information of the web service to obtain a service key, and selecting at least one of the service nodes accordingly, and registering the service key, the node ID of the first service node and the service information to the selected service node, where the difference between the node ID of the selected service node and the service key is minimum.

2. The system of claim 1 wherein the node ID corresponding to respective service node is obtained by encoding the network address of the service node and a time stamp using the encoding function.

3. The system of claim 1 wherein the service information keywords comprise business entity, business service, or web service.

4. The system of claim 1 wherein each service node comprises:
a service address book, comprising the node ID and the network address of at least one of the service nodes; and
a service description repository, comprising the node ID of at least one of the service nodes providing at least one web service, at least service information corresponding to the web service, and the service key corresponding to the service information.

5. The system of claim 4 further comprising a second service node within the service nodes, when the second service node seeks a specific web service, a specific keyword corresponding to the specific web service is encoded using the encoding function to obtain a specific service key corresponding to the specific keyword, and selects a first query node from the service nodes accordingly, and queries a specific service node corresponding to the specific service key from the service description repository of the first query node, where the difference between the specific service key and the node ID of the first query node is minimal.

6. The system of claim 5 wherein if the service description repository of the first query node does not comprise the specific service key, the second service node selects a second query node from the service address book of the first query node according to the specific service key, and queries the specific service node corresponding to the specific service key from the service description repository of the second query node, where the difference between the specific service key and the node ID of the second query node is minimal.

7. The system of claim 6 wherein the second service node further receives the node ID and the network address of the second query node from the first query node and stores the node ID and the network address of the second query node in the service address book of the second service node.

8. The system of claim 5 wherein the second service node further receives the node ID and the network address of the specific service node from the first query node and stores the node ID and the network address of the specific service node in the service address book of the second service node.

9. A web service management system, comprising:
a plurality of service nodes, each having a node ID, where the node ID is obtained by encoding a network address of the service node using an encoding function, each service node comprising:
a service address book, comprising the node ID and the network address of at least one of the service nodes; and
a service description repository, comprising the node ID of at least one of the service nodes providing at least one web service, at least service information corresponding to the web service, and the service key corresponding to the service information; and
a second service node within the service nodes, when the second service node seeks a specific web service, a specific keyword corresponding to the specific web service is encoded using the encoding function to obtain a specific service key corresponding to the specific keyword, and selects a first query node from the service nodes accordingly, and queries a specific service node corresponding to the specific service key from the service description repository of the first query node, where the difference between the specific service key and the node ID of the first query node is minimal.

10. The system of claim 9 wherein if the service description repository of the first query node does not comprise the specific service key, the second service node selects a second query node from the service address book of the first query node according to the specific service key, and queries the specific service node corresponding to the specific service key from the service description repository of the second query node, where the difference between the specific service key and the node ID of the second query node is minimal.

11. The system of claim 10 wherein the second service node further receives the node ID and the network address of the second query node from the first query node and stores the node ID and the network address of the second query node in the service address book of the second service node.

12. The system of claim 9 wherein the second service node further receives the node ID and the network address of the specific service node from the first query node and stores the node ID and the network address of the specific service node in the service address book of the second service node.

13. A web service management method, comprising:
providing a plurality of service nodes, each having a node ID, where the node ID is obtained by encoding a network address of the service node using an encoding function;
a first service node with at least one web service using the encoding function to encode at least service information of the web service to obtain a service key;
selecting at least one of the service nodes according to the service key, where the difference between the node ID of the selected service node and the service key is minimum; and
registering the service key, the node ID of the first service node and the service information to the selected service node.

14. The method of claim 13 further comprising using the encoding function to encode the network address of the service node and a time stamp to obtain the node ID corresponding to respective service node.

15. The method of claim 13 wherein the service information comprises keywords of business entity, business service, or web service.

16. The method of claim 13 further comprising providing a service address book and a service description repository in respective service node, wherein the service address book comprises the node ID and the network address of at least one of the service nodes, and the service description repository comprises the node ID of at least one of the service nodes providing at least one web service, at least service information corresponding to the web service, and the service key corresponding to the service information.

17. The method of claim 16, when a second service node seeks a specific web service, the method further comprises the steps of:
using the encoding function to encode a specific keyword corresponding to the specific web service to obtain a specific service key corresponding to the specific keyword;
selecting a first query node from the service nodes according to the specific service key, where the difference between the specific service key and the node ID of the first query node is minimal; and
querying a specific service node corresponding to the specific service key from the service description repository of the first query node.

18. The method of claim 17, if the service description repository of the first query node does not comprise the specific service key, the method further comprises the steps of:
selecting a second query node from the service address book of the first query node according to the specific service key, where the difference between the specific service key and the node ID of the second query node is minimal; and
querying the specific service node corresponding to the specific service key from the service description repository of the second query node.

19. The method of claim 18 further comprising:
receiving the node ID and the network address of the second query node from the first query node by the second service node; and
storing the node ID and the network address of the second query node in the service address book of the second service node.

20. The method of claim 17 further comprising:
receiving the node ID and the network address of the specific service node from the first query node by the second service node; and
storing the node ID and the network address of the specific service node in the service address book of the second service node.

21. A web service management method, comprising:
providing a plurality of service nodes, each having a node ID, where the node ID is obtained by encoding a network address of the service node using an encoding function;
providing a service address book and a service description repository in respective service node, wherein the service address book comprises the node ID and the network address of at least one of the service nodes, and the service description repository comprises the node ID of at least one of the service nodes providing at least one web service, at least service information corresponding to the web service, and the service key corresponding to the service information;
when a second service node seeks a specific web service, using the encoding function to encode a specific keyword corresponding to the specific web service to obtain a specific service key corresponding to the specific keyword;
selecting a first query node from the service nodes according to the specific service key, where the difference between the specific service key and the node ID of the first query node is minimal; and
querying a specific service node corresponding to the specific service key from the service description repository of the first query node.

22. The method of claim 21, if the service description repository of the first query node does not comprise the specific service key, the method further comprises the steps of:
selecting a second query node from the service address book of the first query node according to the specific service key, where the difference between the specific service key and the node ID of the second query node is minimal; and
querying the specific service node corresponding to the specific service key from the service description repository of the second query node.

23. The method of claim 22 further comprising:
receiving the node ID and the network address of the second query node from the first query node by the second service node; and
storing the node ID and the network address of the second query node in the service address book of the second service node.

24. The method of claim 21 further comprising:
receiving the node ID and the network address of the specific service node from the first query node by the second service node; and
storing the node ID and the network address of the specific service node in the service address book of the second service node.

25. A machine-readable storage medium comprising a computer program, which, when executed, causes a device having at least one web service to perform a web service management method for use in a plurality of service nodes, each service node having a node ID, the node ID is obtained by encoding a network address of the service node using an encoding function, the method comprising:
using the encoding function to encode at least service information of the web service to obtain a service key;
selecting at least one of the service nodes according to the service key, where the difference between the node ID of the selected service node and the service key is minimum; and
registering the service key, the node ID of the device and the service information to the selected service node.

26. A machine-readable storage medium comprising a computer program, which, when executed, causes a device having at least one web service to perform a web service management method for use in a plurality of service nodes, each service node having a node ID, the node ID is obtained by encoding a network address of the service node using an encoding function, and each service node comprising a service address book and a service description repository, wherein the service address book comprises the node ID and the network address of at least one of the service nodes, and the service description repository comprises the node ID of at least one of the service nodes providing at least one web service, at least service information corresponding to the web service, and the service key corresponding to the service information, the method comprising:
when a second service node seeks a specific web service, using the encoding function to encode a specific keyword corresponding to the specific web service to obtain a specific service key corresponding to the specific keyword;
selecting a first query node from the service nodes according to the specific service key, where the difference between the specific service key and the node ID of the first query node is minimal; and
querying a specific service node corresponding to the specific service key from the service description repository of the first query node.
